(19) United States
(12) Patent Application Publication
(10) Pub. No.: US 2005/0134910 A1
(43) Pub. Date: Jun. 23, 2005

(54) Network printer capable of displaying printing state and method thereof

(75) Inventors: Jin-Hyung Kim, Suwon-si (KR); Byoung-yue Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/001,299

(22) Filed: Dec. 2, 2004

(30) Foreign Application Priority Data
Dec. 22, 2003 (KR) 2003-94741

(51) Int. Cl. G06F 15/00

(52) U.S. Cl. 358/1.15

(57) ABSTRACT

A network printer and a method for displaying a printing state for a network printer are disclosed. The network printer includes a display, an interface for receiving print data to be printed and related information of the print data from a connected host, a calculator for calculating a receiving rate of the print data and a remaining time until reception of the print data is completed based on the related information received by the interface, and a controller for updating at predetermined intervals the receiving rate of the print data and the remaining time calculated by the calculator and displaying the updated receiving rate and remaining time on the display. The network printer can display information on the receiving rate of the received print data and the remaining time in real time, and thus can improve the user's convenience.

This application claims benefit under 35 U.S.C. §119(a) from Korean Patent Application No. 2003-94741 filed on Dec. 22, 2003, the entire contents of which are incorporated herein by reference.

### BACKGROUND OF THE INVENTION

1. Field of the Invention

The present invention relates to a network printer and a method for displaying the printing state for a network printer. More particularly, the present invention relates to a network printer and a method for displaying the printing state for a network printer that can display the printing state of print data received from a computer connected to the network printer when the print data is printed through the network printer.

2. Description of the Related Art

Most printers recently commercialized in the market can be shared and used by several computers through a Local Area Network (LAN). This kind of printer, which is called a network printer, is connected to a plurality of computers through the LAN, and operates by storing print information transferred from the respective computers in a storage medium. The printer forms an image based on the stored print information and prints the image on printing paper.

FIG. 1 is a schematic view illustrating a general network printing system. Referring to FIG. 1, the network printing system includes host computers 10, 20 and 30, a hub 40, and a network printer 50. The respective host computers 10, 20 and 30 are connected to the network printer 50 through the hub 40.

The network printer 50 is allocated with an Internet Protocol (IP) address in the same manner as the respective host computers 10, 20 and 30. Each host computer 10, 20 and 30, after a printer driver is installed, sets a port of the printer driver to the IP address allocated to the network printer 50, and outputs a printout command to the set IP address. If the network printer 50 receives printout commands from the respective host computers 10, 20 and 30, it discriminates the IPs of the host computers 10, 20 and 30 that output the printout commands, and performs the printing operation according to the print information corresponding to the received printout commands.

In the general network printing system as described above, if the plurality of the computers connected to one network printer simultaneously transfer printout commands to the network printer, the network printer sequentially performs the printing work in accordance with the received printout commands. A user of the respective host computer connected to the network printer can recognize the present printing state through a printing manager program displayed on the host computer, but the network printer side cannot recognize the state of printing work. In order to solve this problem, a network printer that can display an output state of the print data has been developed.

FIG. 2 is a block diagram illustrating the construction of a conventional network printer that can display an output state of print data. A network printer 200 connected to a PC 100 that is a host, includes a host interface 201, a manipulation panel 203, a controller 205, a storage 207, an engine interface 209, and a printing part 211. The network printer 200 is connected to one PC 100 for the sake of convenience in the explanation, however, it is natural that the network printer 200 may be connected to a plurality of PCs 100 as described above.

The host interface 201 is implemented by an interface that provides a bi-directional communication between the PC 100 and the printer. The host interface 201 receives various kinds of commands and data from the PC 100, and transmits output signals to the PC 100, for example, a status signal of the printer 200.

The manipulation panel 203 is provided with a plurality of keys for inputting various kinds of commands and a display for displaying information produced according to the operation of the printer 200. The controller 205 communicates with the PC 100 through the host interface 201 and prints work by controlling the printing part 211 according to the commands received from the PC 100 and the manipulation panel 203.

The memory or storage 207 stores a drive program for operating the controller 205 and initial data, and temporarily stores various kinds of data produced according to the operation of the controller 205. The engine interface 209 is connected between the controller 205 and the printing part 211, and facilitates the transmission of input and output signals to and from the controller 205. The printing part 211 includes various kinds of devices for transferring printing papers and performing a printing operation under the control of the controller 205.

FIG. 3 is a flowchart illustrating a conventional network printing method performed by the network printer of FIG. 2. Referring to FIG. 3, if data to be printed is not received from the PC 100 with the network printer 200 being connected to the PC 100, the network printer 200 is in an initialization and data reception waiting state at step S301.

When transmitting a document or image data prepared by an application program to the network printer 200 for printing, the host PC 100 transmits information related to the data to be printed to the network printer 200 before it transmits the document or image data. The information related to the data to be printed, which is transmitted by the PC 100, includes a Uniform Resource Identifiers (URI) of the data to be printed and the whole size of the data, such as 10.5 Kilobytes, to be printed.

The network printer 200 receives the data-related information transmitted from the PC 100 at step S303, and simultaneously displays that the data reception is in progress on a display provided in the manipulation panel 203 at step S305.

If the transmission of the information related to the data to be printed is completed, the PC 1 00 transmits the data to be printed to the network printer 200 at step S307. The network printer 200 determines whether the reception of the print data transmitted from the PC 100 is completed at predetermined intervals at step S309. If it is determined that the reception of the print data is completed, it displays the completion of the data reception on the display at step S311. If it is determined that the reception of the print data is not completed, the controller 205 of the network printer 200 performs the printing work by transmitting the received print data to the printing part 211.

As described above, the conventional network printer displays that the data is being received at a time point when the data reception starts, and displays that the data reception is completed at a time point when the data reception is completed. That is, the conventional network printer can display the receiving state of the print data only at the data-reception start time point and at the data-reception completion time point, but cannot provide information on the data receiving state during the time from the data-reception start time point to the data-reception completion time point. Accordingly, if the plurality of the computers, which are connected to the network printer, simultaneously transmit the print data to the network printer, a user who has transmitted the subsequent print data cannot recognize to what extent the printing is performed by the network printer or how much waiting time is required until the print data of the user himself or herself is printed.

### SUMMARY OF THE INVENTION

The present invention has been developed in order to solve the above drawbacks and other problems associated with the conventional arrangement. An exemplary aspect of the present invention provides a network printer and a method for displaying a printing state for a network printer that can improve the user's convenience by displaying in real-time information on the receiving rate of print data and the remaining time.

The foregoing and other aspects and advantages are substantially realized by providing a network printer, according to an exemplary embodiment of the present invention, which comprises a display, an interface, a calculator, and a controller.The interface receives print data to be printed and related information of the print data from a connected host. The calculator calculates a receiving rate of the print data and a remaining time until reception of the print data is completed based on the related information received by the interface. The controller updates at predetermined intervals the receiving rate of the print data and the remaining time calculated by the calculator and displays the updated receiving rate and remaining time..

It is preferable that the related information that the interface receives from the host includes information on a whole size of the print data, such as 10.5 Kilobytes, and uniform resource identifiers (URI) of the print data.

It is also preferable that the calculator includes a search part for searching for the size of the received print data, and calculates the receiving rate and the remaining time based on the size of the print data searched by the search part.

It is also preferable that the calculator calculates the receiving rate and the remaining time by the following equations:
Receiving rate (%)=(Size of received data/Whole size of print data)×100;
Remaining time (seconds)=(Whole size of print data−Size of received data)/Receiving speed per second,
wherein the receiving speed per second=Size of received data/Elapsed time for receiving in seconds, Size of receiving data and Whole size of print data is expressed in either Kilobytes, Kilobits or Megabits.

In another aspect of the present invention, there is provided a method for displaying the printing state for a network printer which comprises the steps of (a) receiving print data to be printed and related information of the print data from a connected host, (b) calculating a receiving rate of the print data and a remaining time until reception of the print data is completed based on the related information received in the step (a), and (c) updating at predetermined intervals the receiving rate of the print data and the remaining time calculated in the step (b), and displaying the updated receiving rate and remaining time on a display.

It is preferable that the related information received in step (a) includes information on a whole size of the print data and uniform resource identifiers (URI) of the print data.

It is also preferable that step (b) includes the step of searching for the size of the received print data. The receiving rate and the remaining time are calculated based on the size of the print data searched in step (d).

It is also preferable that step (b) calculates the receiving rate and the remaining time by a following equations:
Receiving rate (%)=(Size of received data/Whole size of print data)×100;
Remaining time (seconds)=(Whole size of print data−Size of received data)/Receiving speed per second,
wherein the receiving speed per second=Size of received data/Elapsed time in seconds, Size of receiving data and Whole size of print data is expressed in either Kilobytes, Kilobits or Megabits.

The network printer as described above can display the printing state of the print data transmitted from a connected computer when it prints the print data.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a schematic view illustrating a general network printing system;

FIG. 2 is a block diagram illustrating the construction of a conventional network printer that can display an output state of print data;

FIG. 3 is a flowchart illustrating a conventional network printing method performed by the network printer of FIG. 2;

FIG. 4 is a block diagram illustrating the construction of a network printer according to an exemplary embodiment of the present invention;

FIG. 5 is a flowchart illustrating a method of displaying a printing state performed by the network printer of FIG. 4 according to an embodiment of the present invention; and

FIG. 6 is a view illustrating an example of displaying a printing state through the network printer of FIG. 4 according to an embodiment of the present invention.

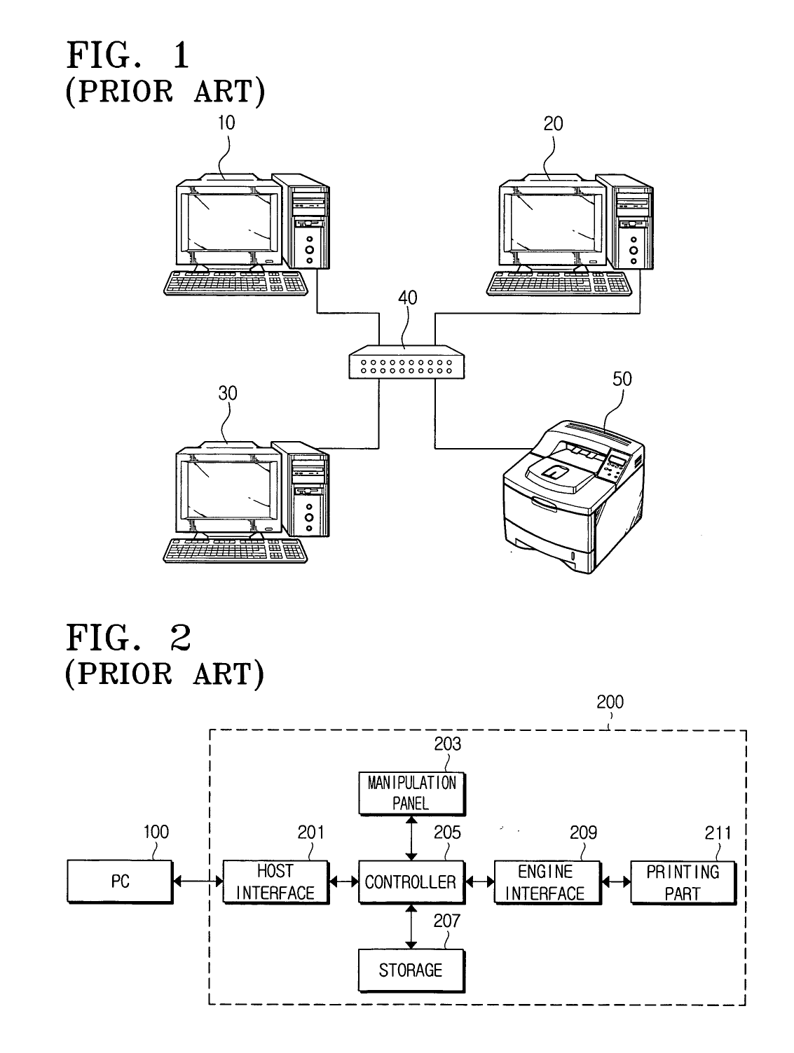

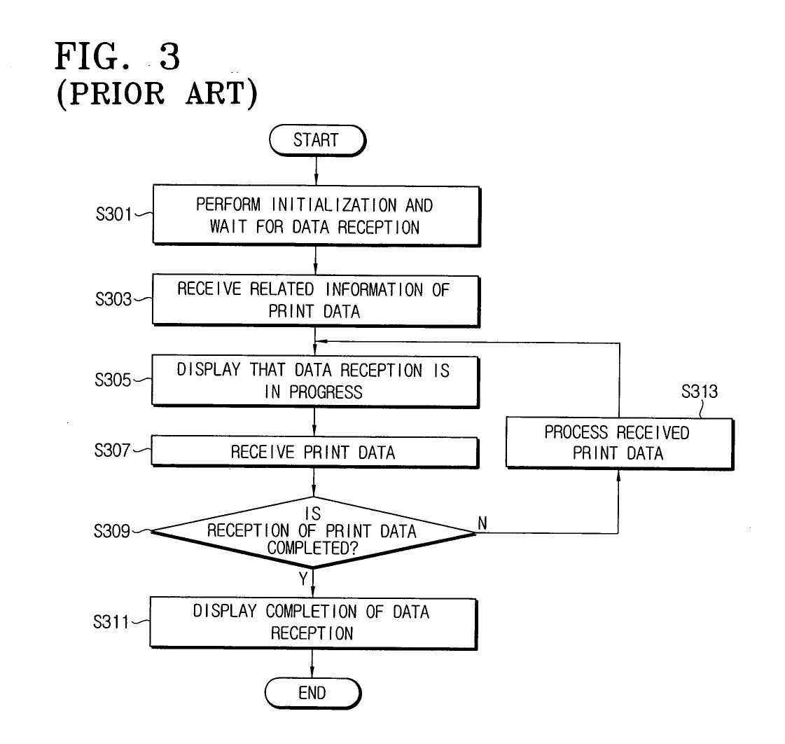

### DETAILED DESCRIPTION OF EXEMPLARY EMBODIMENTS

Certain exemplary embodiments of the present invention will now be described in greater detail with reference to the accompanying drawings.

The matters defined in the description such as a detailed construction and elements are provided to assist in a comprehensive understanding of the invention. Thus, it is apparent that the present invention can be carried out without those defined matters. Also, well-known functions or constructions will be omitted for he sake of clarity.

FIG. 4 is a block diagram illustrating the construction of a network printer according to an embodiment of the present invention.

Referring to FIG. 4, the network printer 400 according to an exemplary embodiment of the present invention includes an interface 410, a calculator 420, a controller 430, a display 440, and a printing part 450. The network printer 400 is connected to a computer 300 through the interface 410. Also, the calculator 420 is preferably provided with a search part 423.

The computer 300 converts a document or image data prepared through an installed application program into print data in a format such as Printer Command Language (PCL), and transmits the print data to the network printer 400 in order to print the prepared document or image data. The computer 300 transmits related information of the document or image data (hereinafter referred to as ‘print data’) to the network printer 400 together with the document or image data converted into the PCL. The related information includes information on the whole size of the print data and URI of the print data. Although the computer 300 is connected to the network printer 400 in this embodiment, a mobile device such as a Personal Digital Assistant (PDA), portable phone, and notebook computer, may access the network printer 400 through a wireless interface. The mobile device or the computer may be called a host.

The interface 410 receives the print data and the related information of the print data transmitted from the computer 300. The calculator 420 calculates the receiving rate of the print data and the remaining time until the reception of the print data is completed based on the related information received from the computer 300 through the interface 410. The search part 423 provided in the calculator 420 searches for the size of the received print data. The size of the received print data denotes the size of the print data received until the present time.

The calculator 420 calculates the receiving rate and the remaining time by the following equation based on the size of the received print data searched by the search part 423.
Receiving rate (%)=(Size of received data/Whole size of print data)×100
Remaining time (seconds)=(Whole size of print data−Size of received data)/Receiving speed per second [Equation 1]

In the above equation, the receiving speed per second=Size of received data/Elapsed time for receiving in seconds, Size of receiving data and Whole size of print data is expressed in either Kilobytes, Kilobits or Megabits.

The controller 430 updates at predetermined intervals the receiving rate of the print data and the remaining time calculated by the calculator 420, and displays the updated receiving rate and remaining time on the display 440. Also, the controller 430 controls the printing part 450 to print the received print data.

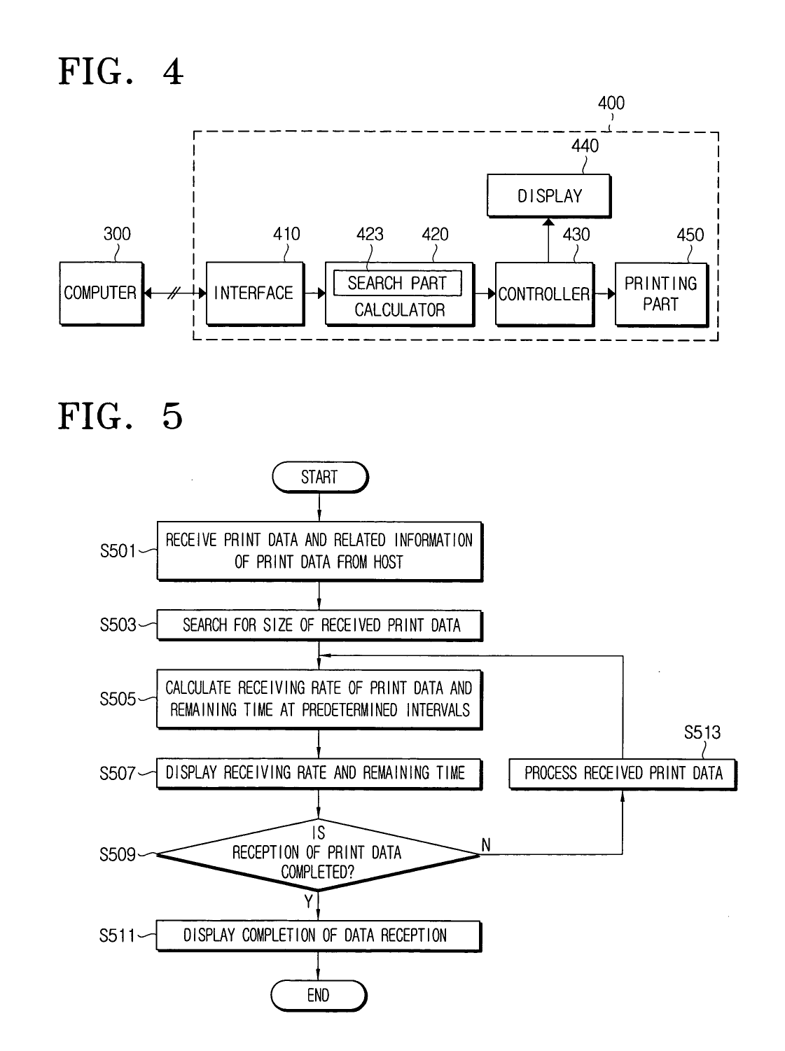

FIG. 5 is a flowchart illustrating a method of displaying a printing state performed by the network printer of FIG. 4 according to an embodiment of the invention.

Referring to FIG. 5, the network printer 400 receives the print data and the related information of the print data from the host 300 through the interface 410 at step S501. If the print data and the related information of the print data are received from the host 300, the search part 423 in the calculator 420 searches for the size of the received print data until the present time among the received print data at step 503.

If the size of the received print data until the present time is searched through the search part 423, the calculator 420 calculates the receiving rate of the received print data and the remaining time until the reception of the print data is completed according to equation 1 based on the whole size of the print data and the URI information of the print data included in the received related information at step S505.

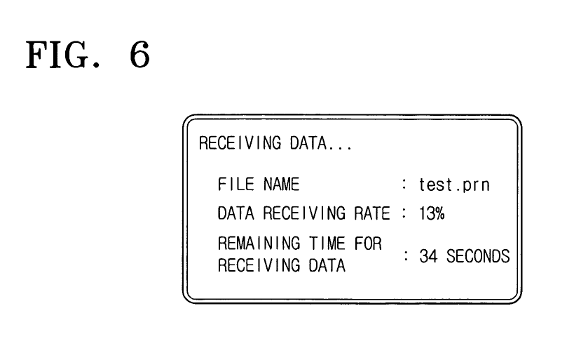

The controller 430 transmits the receiving rate of the received print data and the remaining time calculated by the calculator 420 to the display 440, and the display 440 displays the receiving rate and the remaining time received from the calculator 420 at step S507. FIG. 6 illustrates an example of the display of a printing state through the network printer of FIG. 4 according to an embodiment of the present invention. Referring to FIG. 6, the URI of the print data being received is ‘test.prn’, the receiving rate of the print data received until the present time is 13%, and the remaining time until the reception of the print data is completed is 34 seconds.

If the reception of the print data is completed at step S509, the display 440 displays the completion of the print data reception at step S511. The display 440 may display the completion of the data reception in a manner that it displays 100% as the receiving rate of the print data and ‘0’ second as the remaining time, or in a manner that it displays an expression ‘Data reception completed’.

Until the reception of the print data is completed, the controller 430 controls the printing part 450 to print the received print data at step S513. The controller 430 may store the received data page by page and print the stored print data in the form of an image through the printing part 450, or may print the received print data line by line. Consequently, the network printer according to an exemplary embodiment of the present invention can display information on the receiving rate of the received print data and the remaining time in real-time, and thus can improve the user's convenience.

The foregoing embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A network printer comprising:
a display;
an interface for receiving print data to be printed and related information of the print data from a connected host;
a calculator for calculating a receiving rate of the print data and a remaining time until reception of the print data is completed based on the related information received by the interface; and
a controller for updating, at predetermined intervals, the receiving rate of the print data and the remaining time calculated by the calculator, and displaying the updated receiving rate and remaining time on the display.

2. The network printer as claimed in claim 1, wherein the related information that the interface receives from the host includes information on a whole size of the print data and uniform resource identifiers (URI) of the print data.

3. The network printer as claimed in claim 2, wherein the calculator comprises a search part for searching for the size of the received print data,
and the receiving rate and the remaining time are calculated based on the size of the print data searched by the search part.

4. The network printer as claimed in claim 3, wherein the calculator calculates the receiving rate and the remaining time by the following equation:
Receiving rate (%)=(Size of received data/Whole size of print data)×100;
Remaining time (seconds)=(Whole size of print data−Size of received data)/Receiving speed per second,
wherein the receiving speed per second=Size of received data/Elapsed time for receiving.

5. A method of displaying a printing state for a network printer, comprising the steps of:
(a) receiving print data to be printed and related information of the print data from a connected host;
(b) calculating a receiving rate of the print data and a remaining time until reception of the print data is completed based on the related information received in the step (a); and
(c) updating at predetermined intervals the receiving rate of the print data and the remaining time calculated in step (b), and displaying the updated receiving rate and remaining time on a display.

6. The method as claimed in claim 5, wherein the related information received in step (a) includes information on a whole size of the print data and uniform resource identifiers (URI) of the print data.

7. The method as claimed in claim 6, wherein the step (b) comprises the step of searching for the size of the received print data,
and the receiving rate and the remaining time are calculated based on the size of the print data searched in step (d).

8. The method as claimed in claim 7, wherein step (b) calculates the receiving rate and the remaining time by a following equation
Receiving rate (%)=(Size of received data/Whole size of print data)×100
Remaining time (seconds)=(Whole size of print data−Size of received data)/Receiving speed per second,
wherein the receiving speed per second=Size of received data/Elapsed time.
